(19) United States
(12) Patent Application Publication
(10) Pub. No.: US 2019/0371147 A1
(43) Pub. Date: Dec. 5, 2019

(54) FIRE ALARMING METHOD AND DEVICE

(71) Applicant: BOE Technology Group Co., Ltd., Beijing (CN)

(72) Inventors: Minbiao Zhou, Beijing (CN); Yu Gu, Beijing (CN)

(21) Appl. No.: 16/250,047

(22) Filed: Jan. 17, 2019

(30) Foreign Application Priority Data
May 31, 2018 (CN) 201810548698.9

(51) Int. Cl. G08B 17/06; G06F 17/16; G06F 17/18

(52) U.S. Cl. CPC G08B 17/06; G06F 17/18; G06F 17/16

(57) ABSTRACT

Provided are a fire alarming method and device. The method includes: acquiring the n types of environmental data of a current moment by the sensing module; determining a fire probability corresponding to each type of environmental data according to the n types of environmental data; determining a fusion probability of the n types of environmental data according to the n types of environmental data and the fire probability corresponding to each type of environmental data; and sending alarm information when the fusion probability is larger than a specified probability value. The fusion probability is the probability determined by comprehensively considering multiple types of environmental data, and the accuracy is relatively high. Therefore, the accuracy of the alarm information is also relatively high, which solves the problem that the accuracy of the alarm information is relatively low, and improves the accuracy of an alarming result sent by the fire alarming device.

This application claims priority to Chinese Patent Application No. 201810548698.9, filed on May 31, 2018 and titled “FIRE ALARMING METHOD AND DEVICE”, the entire contents of which are incorporated herein by reference.

### TECHNICAL FIELD

The present disclosure relates to a fire alarming method and device.

### BACKGROUND

In some places where oil fumes are accumulated or flammable gases are existed, the possibility of fire is relatively large. It is a current development trend to set up fire alarming devices in these places.

There is fire alarming method in the related art, which is used in a fire alarming device. The fire alarming device includes a smoke sensor and a temperature sensor. In this method, two types of environmental data, i.e., smoke concentration and temperature are acquired by using the smoke detector and the temperature sensor. A fire probability corresponding to the smoke concentration and a fire probability corresponding to the temperature are respectively determined according to the smoke concentration and the temperature. Alarm information is sent when any of the two fire probabilities is larger than a specified probability value.

### SUMMARY

There are provided a fire alarming method and device in embodiments of the present disclosure. The technical solutions are as follows.

According to a first aspect of the present disclosure, there is provided a fire alarming method, applied on a fire alarming device, wherein the fire alarming device includes a sensing module for acquiring n types of environmental data, n is larger than or equal to two, and the method includes: acquiring the n types of environmental data at a current moment through the sensing module; determining a fire probability corresponding to each type of environmental data according to the n types of environmental data; determining a fusion probability of the n types of environmental data according to the n types of environmental data and the fire probability corresponding to each type of environmental data; and sending alarm information when the fusion probability is larger than a specified probability value.

Optionally, determining a fusion probability of the n types of environmental data according to the n types of environmental data and the fire probability corresponding to each type of environmental data includes: acquiring a membership degree of each of the n types of environmental data; and determining the fusion probability based on the fire probability corresponding to each type of environmental data and the membership degree of each type of environmental data.

Optionally, a sum of the membership degrees of the n types of environmental data is 1; determining the fusion probability based on the fire probability corresponding to each type of environmental data and the membership degree of each type of environmental data includes: determining the fusion probability according to a probability formula of P=p₁w₁+p₂w₂L+pₙwₙ, wherein P is the fusion probability, pₓ is the fire probability corresponding to one of the n types of environmental data, wₓ is the membership degree of the environmental data corresponding to pₓ, and x satisfies 1≤x≤n.

Optionally, before acquiring a membership degree of each of the n types of environmental data, the method further includes: acquiring m test sets, wherein each test set includes the fire probabilities corresponding to the n types of environmental data acquired by the sensing module at any moment prior to the current moment and an actual fire probability of the any moment prior to the current moment; determining the membership degree of each type of environmental data which minimizes a value of a loss function according to the m test sets, the loss function being: L=Σᵢ₌₁^{m}(Yᵢ−Pᵢ)², wherein P=pᵢ₁w₁+pᵢ₂w₂L+pᵢₙwₙ, L is the value of the loss function, Yᵢ is the actual fire probability in an i-th test set, Yᵢ is 0 or 1, pᵢₓ is the fire probability corresponding to one type of environmental data in the i-th test set, and x satisfies 1≤x≤n.

Optionally, determining a membership degree of each type of environmental data which minimizes a value of a loss function includes: determining the membership degree of each type of environmental data which minimizes the value of the loss function by using a gradient descent algorithm.

Optionally, sending alarm information when the fusion probability is larger than a specified probability value includes: sending the alarm information to a first terminal when the fusion probability is larger than the specified probability value; and sending the alarm information to a second terminal when a first feedback of the first terminal is not received within a first preset time period.

Optionally, the method further includes: determining that a fire occurs when the first feedback of the first terminal is received within the first preset time period, and the first feedback indicates that the fire occurs; and determining that a fire occurs when a second feedback of the second terminal is received within a second preset time period, and the second feedback indicates that the fire occurs.

Optionally, the method further includes: determining the fusion probability through the probability formula every predetermined time interval when the second feedback of the second terminal is not received within the second preset time period; determining that the fire occurs when a change trend of the fusion probability increases with time; judging whether the currently determined fusion probability is less than the specified probability value when the change trend of the fusion probability does not increase with time; and determining that the fire occurs, and continuously sending the alarm information to the first terminal and the second terminal when the currently determined fusion probability is not less than the specified probability value.

Optionally, the sensing module includes a visual sensor, and the n types of environmental data comprise an image acquired by the visual sensor at the current moment, wherein determining a fire probability corresponding to each type of environmental data according to the n types of environmental data includes: inputting the image acquired by the visual sensor at the current moment into a fire model to acquire the fire probability corresponding to the image acquired by the visual sensor at the current moment, the fire model being configured to determine a fire occurrence probability according to the image; wherein the fire model is a fire model acquired by training a convolutional neural network with a sample set as training data, the fire model is configured to determine the fire occurrence probability according to the image, the sample set includes a plurality of image samples, the plurality of image samples includes h1 image samples in which the fire occurs and h2 image samples in which no fire occurs, and h1 and h2 are both integers larger than or equal to 1.

Optionally, the fire alarming device further includes a fire extinguishing component, and the fire model is further configured to determine a fire location according to the image, after determining that the fire occurs, the method further includes: inputting the image acquired by the visual sensor at the current moment into the fire model to acquire the fire location of the fire; and controlling the fire extinguishing component to direct at the fire location to extinguish the fire.

Optionally, before controlling the fire extinguishing component to direct at the fire location to extinguish the fire, the method further includes: acquiring image coordinates of the fire location in the image; converting the image coordinates into world coordinates in a world coordinate system according to a coordinate conversion formula of:

$$[ \begin{matrix}u \\ v \\ 1\end{matrix} ] = k [ \begin{matrix}fu & 0 & u 0 \\ 0 & fv & v 0 \\ 0 & 0 & 1\end{matrix} ] [ \begin{matrix}R & T \\ 0 & 1\end{matrix} ] [ \begin{matrix}X \\ Y \\ Z\end{matrix} ] ,$$

wherein u and v are the image coordinates, fu is a focal length of the visual sensor in an x-axis direction, fv is a focal length of the visual sensor in a y-axis direction, k is a scale factor, u0 is an optical center coordinate of the visual sensor in the x-axis direction, v0 is an optical center coordinate of the visual sensor in the y-axis direction, R is a rotation vector of the visual sensor, T is a translation vector of the visual sensor, and X, Y, and Z are the world coordinates.

Optionally, the sensing module includes a visual sensor, the n types of environmental data comprise at least two images acquired by the visual sensor at different moments of a preset time period, and the preset time period is a time period including the current moment and before the current moment, the n types of environmental data comprise an image acquired by the visual sensor at the current moment, determining a fire probability corresponding to each type of environmental data according to the n types of environmental data includes: inputting the at least two images into the fire model to acquire at least two fire probabilities corresponding to the at least two images, the fire model being configured to determine a fire occurrence probability according to the image; and determining a maximum value of the at least two fire probabilities corresponding to the at least two images as a fire probability corresponding to the at least two images; wherein the fire model is a fire model acquired by training a convolutional neural network with a sample set as training data, the fire model is configured to determine the fire occurrence probability according to the image, the sample set includes a plurality of image samples, the plurality of image samples includes h1 image samples in which the fire occurs and h2 image samples in which no fire occurs, and h1 and h2 are both integers larger than or equal to 1.

Optionally, the fire alarming device further includes an alarm, and after determining that the fire occurs, the method further includes: activating the alarm.

According to a second aspect of the present disclosure, there is provided a fire alarming device, including: a sensor, and one or more processors; and a memory. wherein the memory stores therein one or more programs configured to be executed by the one or more processors, and the one or more programs comprise instructions for performing following operations: acquiring the n types of environmental data at a current moment through the sensor; determining a fire probability corresponding to each type of environmental data according to the n types of environmental data; determining a fusion probability of the n types of environmental data according to the n types of environmental data and the fire probability corresponding to each type of environmental data; and sending alarm information when the fusion probability is larger than a specified probability value.

Optionally, the one or more programs comprise instructions for performing following operations: acquiring a membership degree of each of the n types of environmental data; and determining the fusion probability based on the fire probability corresponding to each type of environmental data and the membership degree of each type of environmental data.

Optionally, a sum of the membership degrees of the n types of environmental data is 1; the one or more programs comprise instructions for performing following operation: determining the fusion probability according to a probability formula of P=p₁w₁+p₂w₂L+pₙwₙ, wherein P is the fusion probability, pₓ is the fire probability corresponding to one of the n types of environmental data, wₓ is the membership degree of the environmental data corresponding to pₓ, and x satisfies 1≤x≤n.

Optionally, the one or more programs comprise instructions for performing following operations: acquiring m test sets, wherein each test set includes the fire probabilities corresponding to the n types of environmental data acquired by the sensor at any moment prior to the current moment and an actual fire probability of the any moment prior to the current moment; determining the membership degree of each type of environmental data which minimizes a value of a loss function according to the m test sets, the loss function being: L=Σᵢ₌₁^{m}(Yᵢ−Pᵢ)², wherein P=pᵢ₁w₁+pᵢ₂w₂L+pᵢₙwₙ, L is the value of the loss function, Yᵢ is the actual fire probability in an i-th test set, Yᵢ is one of 0 and 1, pᵢₓ is the fire probability corresponding to one type of environmental data in the i-th test set, and x satisfies 1≤x≤n.

Optionally, the one or more programs comprise instructions for performing following operations: sending the alarm information to a first terminal when the fusion probability is larger than the specified probability value; and send the alarm information to a second terminal when a first feedback of the first terminal is not received within a first preset time period.

According to a third aspect of the present disclosure, there is provided a computer storage medium having instructions stored therein, when the instructions are run on a processor, causing the processor to perform a fire alarm method applied on a fire alarming device including a sensor for acquiring n types of environmental data, n is larger than or equal to two, and the method includes: acquiring the n types of environmental data at a current moment through the sensor; determining a fire probability corresponding to each type of environmental data according to the n types of environmental data; determining a fusion probability of the n types of environmental data according to the n types of environmental data and the fire probability corresponding to each type of environmental data; and sending alarm information when the fusion probability is larger than a specified probability value.

According to a fourth aspect of the present disclosure, there is provided a fire alarm device, including a sensor for acquiring n types of environmental data a memory, a processor, and computer programs stored on the memory and capable of running on the processor, n is greater than or equal to 2, and the processor executes the computer programs for implementing a fire alarm method, including: acquiring the n types of environmental data at a current moment through the sensor; determining a fire probability corresponding to each type of environmental data according to the n types of environmental data; determining a fusion probability of the n types of environmental data according to the n types of environmental data and the fire probability corresponding to each type of environmental data; and sending alarm information when the fusion probability is larger than a specified probability value.

### BRIEF DESCRIPTION OF THE DRAWINGS

FIG. 1 is a flow chart of a fire alarming method according to an embodiment of the present disclosure;

FIG. 2 is a flow chart of another fire alarming method according to an embodiment of the present disclosure;

FIG. 3 is a flow chart of a method for determining the membership degree according to an embodiment of the present disclosure;

FIG. 4 is a flow chart of yet another fire alarming method according to an embodiment of the present disclosure;

FIG. 5 is a flow chart of a method for determining a fire probability corresponding to each type of environmental data according to an embodiment of the present disclosure;

FIG. 6 is a flow chart of still yet another fire alarming method according to an embodiment of the present disclosure;

FIG. 7 is a schematic diagram of a structure of a fire alarming device according to an embodiment of the present disclosure;

FIG. 8 is a schematic diagram of a structure of another fire alarming device according to an embodiment of the present disclosure; and

FIG. 9 is a schematic diagram of a structure of another fire alarming device according to an embodiment of the present disclosure.

### DETAILED DESCRIPTION

The present disclosure will be described in further detail with reference to the accompanying drawings, to present the objects, technical solutions, and advantages of the present disclosure clearer.

In the places where oil fumes are accumulated or flammable gases are existed, fire is likely to occur in the event of an open flame. For example, there are many places in the kitchen where the cooking fume is accumulated for long term, and there may be leakage of natural gas or liquefied gas in a cooker, so once the open flame occurs in the kitchen, it is easy to cause a fire. When the fire occurs, if the fire is not detected in time, the alarm will be delayed, which will endanger life safety and cause huge property losses.

There is provided a fire alarming method in the prior art, which is used in a fire alarming device. The fire alarming device includes a smoke sensor and a temperature sensor. The fire probabilities respectively corresponding to two types of environmental data are respectively determined by two types of environmental data acquired by the smoke detector and the temperature sensor. Alarm information is sent when any of the two fire probabilities is larger than a specified probability value.

However, since the environmental data related to smoke and temperature are easily affected by other factors, resulting in a low accuracy of the sent alarm information. For example, the smoke data collected by the smoke sensor may be affected by the cooking fume generated during normal use of the kitchen, and further the fire probability acquired according to such smoke data may be too large. If the acquired fire probability is larger than the specified probability, a false alarm information may occur. In this case, unnecessary troubles and waste of public resources will be brought to the police and firefighters.

The embodiment of the present application provides a fire alarming method, which can effectively improve the accuracy of the alarm information.

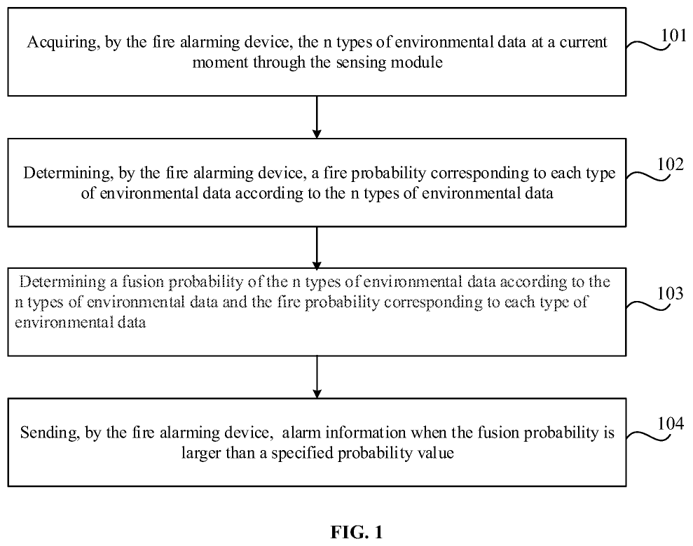

FIG. 1 is a flowchart of a fire alarming method according to an embodiment of the present disclosure, and the fire alarming method is applied on a fire alarming device. The fire alarming device may include a sensing module for acquiring n types of environmental data. The fire alarming method can include the following steps.

In step 101, the n types of environmental data are acquired at a current moment through the sensing module;

In step 102, a fire probability corresponding to each type of environmental data is determined according to the n types of environmental data;

In step 103, a fusion probability of the n types of environmental data is determined according to the n types of environmental data and the fire probability corresponding to each type of environmental data;

In step 104, alarm information is sent when the fusion probability is larger than a specified probability value.

Herein, the environmental data may refer to the data configured to reflect various conditions (such as temperature and smoke concentration) of the environment in which the fire alarming device is located.

The above manner of determining whether to send the alarm information according to the fusion probability is to fuse a plurality of fire probabilities, rather than simply selecting one of the plurality of fire probabilities as a basis for judging whether a fire occurs, so as to acquire the fusion probability capable of reflecting the overall state of the current environment corresponding to the n types of environmental data, and perform the judgment according to the fusion probability.

In summary, the fire alarming method provided by the embodiments of the present disclosure acquires the fire probabilities corresponding to the plurality of environmental data, and determines the fusion probability of the fire occurrence based on the fire probabilities corresponding to the plurality of environmental data. When the fusion probability is larger than a specified probability value, alarm information is sent. The fusion probability is the probability determined by comprehensively considering a plurality of environmental data, and the accuracy is relatively high. Therefore, the accuracy of the alarm information is also relatively high. The problem that the accuracy of the alarm information in the related art is relatively low is solved. The effect of improving the accuracy of an alarming result sent by the fire alarming device is achieved.

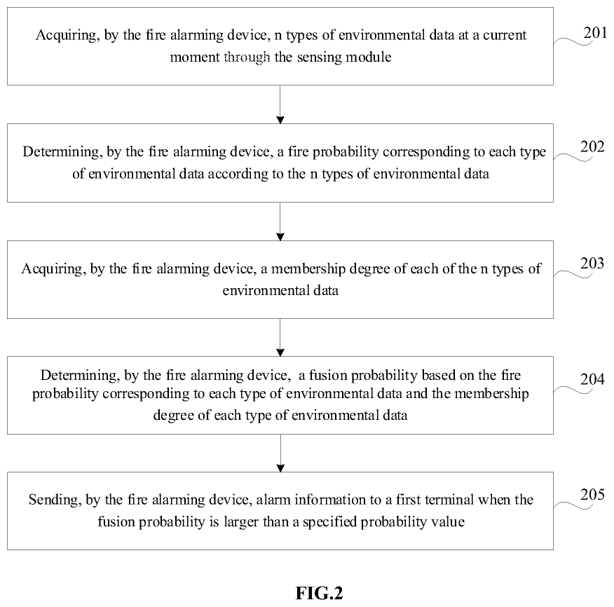

FIG. 2 shows a flowchart of another fire alarming method provided by an embodiment of the present disclosure. The fire alarming method is applied on a fire alarming device. The fire alarming device may include a sensing module for acquiring n types of environmental data, and n≥2. The fire alarming method may include the following steps.

In step 201, the fire alarming device acquires n types of environmental data at a current moment through the sensing module.

The sensing module may include n sensors, each of which may acquire one type of environmental data. For example, the sensing module may include four sensors, which are a smoke sensor, a temperature sensor, a flammable gas sensor, and a visual sensor respectively. The smoke sensor may acquire the environmental data including smoke concentration information in the air. The temperature sensor may acquire the environmental data including the environmental temperature. The flammable gas sensor may acquire the environmental data including the flammable gas concentration in the air. The visual sensor may acquire the environmental data including an environmental image. The fire alarming device may acquire the n types of environmental data of the current moment via n sensors disposed in the sensing module. Of course, in other possible embodiments, the fire alarming device can acquire n types of environmental data of the current moment via s sensors disposed in the sensing module, and s is an integer larger than n. In this case, one type of environmental data may be acquired by multiple sensors. For example, the smoke data may be acquired via an ionized smoke sensor, and/or a photoelectric smoke sensor, which is not limited by the embodiments of the present disclosure.

In step 202, the fire alarming device determines a fire probability corresponding to each type of environmental data according to the n types of environmental data.

The manner of determining the fire probabilities according to different environmental data may be the same or different. The environmental data (such as smoke concentration, temperature, and flammable gas concentration) in which the values can be measured may be determined according to the corresponding relationship between the predetermined values and the fire probabilities.

Optionally, for each type of environmental data, a plurality of fire threshold intervals corresponding to each type of environmental data may be set, and each fire threshold interval may correspond to one fire probability. The fire alarming device may compare the n types of environmental data with the plurality of fire threshold intervals corresponding to the environmental data, thereby determining the fire probability corresponding to each type of environmental data. For example, the sensing module may acquire the environmental data including a carbon monoxide (CO) concentration. The plurality of fire threshold intervals of such environmental data may include the CO concentration of smaller than 10 parts per million (ppm), larger than 10 ppm and smaller than 15 ppm, larger than 15 ppm and smaller than 20 ppm, etc. The fire probabilities corresponding to the above three fire threshold intervals may be 0.3, 0.6, and 0.85 respectively. According to the fact that the acquired environmental data is the CO concentration of 12 ppm, the fire alarming device can determine that the fire probability corresponding to the environmental data is 0.6, since 12 ppm is larger than 10 ppm and smaller than 15 ppm.

Optionally, the fire threshold intervals and the fire probability corresponding thereto may be acquired according to actual experience and fire statistical data, and the above data are only schematic description.

Optionally, the method for determining the fire probability according to image data may refer to the manner of determining the fire probability in an image recognition technology of the related art, which is not repeated in detail here.

In step 203, the fire alarming device acquires a membership degree of each of the n types of environmental data.

The membership degree of each of the n types of environmental data may be configured to describe the importance of such environmental data in the process of fire alarming: the higher the membership degree is, the more accurately the environmental data corresponding to the membership degree can reflect the possibility of fire occurrence. There are many manners for determining the membership degree. The following two manners are used as an example for description.

The first manner: the membership degree of each of the n types of environmental data is assigned to a value manually. The staff can assign a value to the membership degree of each type of environmental data through their own experience.

The second manner based on historical fire data, the membership degree of each of the n types of environmental data is acquired through calculation. The historical fire data may be acquired through storing an alarming result after the fire alarming is performed by using the fire alarming method provided in the embodiments of the present disclosure in the past time (that is, the historical time period). The alarming result may include the fire probability corresponding to each type of environmental data acquired when the fire alarming method provided in the embodiments of the present disclosure is adopted for fire alarming, and a probability of a real fire in such fire alarming (the fire probability is 0 when the fire occurs actually, and the fire probability is 0 when no fire occurs actually). The alarming result is more and more abundant as the times of fire alarming performed by adopting the fire alarming method provided in the embodiments of the present disclosure increase. The membership degree may be a parameter predetermined through calculation and stored in the fire alarming device.

Optionally, when the membership degree is determined for the first time by using the second manner of determining the membership degree, an initial value may be firstly assigned to the membership degree of each type of environmental data by using the above first manner of determining the membership degree. Afterwards, based on the historical fire data, the membership degree of each of the n types of environmental data is acquired by calculation.

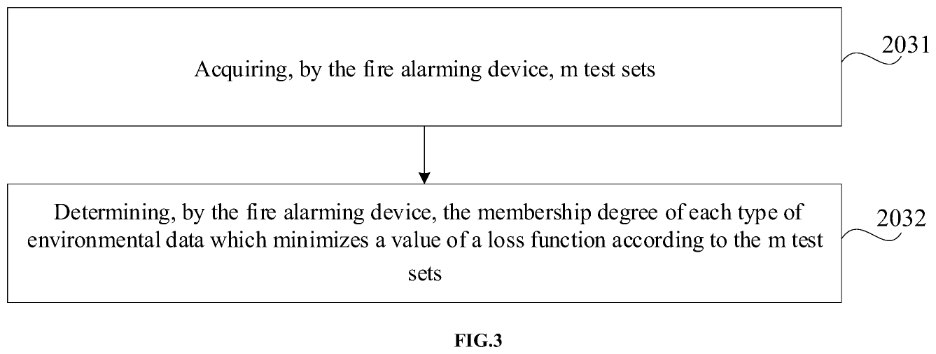

As can be seen from the above description, the membership degree determined by the first manner of determining the membership degree is a fixed value, while the membership degree determined by the second manner of determining the membership degree can be adjusted in real time according to the historical fire data. The membership degree determined in the second manner can be adjusted in real time according to the update of the historical fire data, so the determined membership degree is more accurate and closer to an actual situation. The second manner of determining the membership degree is taken as an example for explanation in the following. As shown in FIG. 3, the method of determining the membership degree may include the following sub-steps.

In sub-step 2031, the fire alarming device acquires m test sets.

Each of the test sets includes the fire probabilities corresponding to the n types of environmental data acquired by the sensing module at any moment before the current moment and an actual fire probability of the any moment. The fire probabilities corresponding to the n types of environmental data acquired at any moment may be the fire probability corresponding to each type of environmental data determined according to the n types of environmental data in the above step 202 at such moment. The actual fire probability of any moment may be the probability that the fire actually occurs at such moment, and the probability may be 0 (no fire occurs) or 1 (the fire occurs). The actual fire probability may be manually calibrated by staff.

Optionally, the test set may be stored in a local server (or a local memory) of the fire alarming device, or may be stored in a remote server (or a remote memory) connected to the fire alarming device, which is not limited by the embodiments of the present disclosure. The fire alarming device may acquire m test sets from the plurality of test sets stored in the local server and/or the remote server for subsequent calculation. The number of the plurality of test sets may increase as the times of the fire alarming performed by using the fire alarming method provided in the embodiments of the present disclosure increase.

In sub-step 2032, the fire alarming device determines the membership degree of each type of environmental data which minimizes a value of a loss function according to the m test sets.

The loss function can be configured to estimate the degree of inconsistency between the fire probabilities corresponding to the n types of environmental data acquired at any moment in the fire alarming device and the actual fire probability at such any moment. The smaller the degree of inconsistency is, that is, the smallest the value of the loss function is, the more accurate the fire probability corresponding to each type of environmental data determined by the fire alarming device is.

Optionally, the loss function may be L=Σᵢ₌₁^{m}(Yᵢ−Pᵢ)².

Herein, P=pᵢ₁w₁+pᵢ₂w₂L+pᵢₙwₙ, L is the value of the loss function and Yi is the actual fire probability in an i-th test set. Yᵢ may be 0 or 1. pᵢₓ is the fire probability corresponding to one type of environmental data in the i-th test set. Of course, the loss function may also be in other forms, and the expression of the loss function shown in the embodiments of the present disclosure is merely exemplary.

Herein, there are many manners of acquiring the membership degree of each type of environmental data which minimizes the value of the loss function. For example, the membership degree of each type of environmental data which minimizes the value of the loss function may be acquired by using a gradient descent algorithm (the gradient descent algorithm may be configured to solve the maximum value or the minimum value of the function).

In step 204: the fire alarming device determines a fusion probability based on the fire probability corresponding to each type of environmental data and the membership degree of each type of environmental data.

The sum of the membership degrees of the n types of environmental data may be 1. The fire alarming device may determine the fusion probability based on the fire probability corresponding to each type of environmental data and the membership degree of each type of environmental data according to a probability formula.

Optionally, the probability formula may be: P=p₁w₁+p₂w₂L+pₙwₙ, wherein P is the fusion probability, pₓ is the fire probability corresponding to one of n types of environmental data, wₓ is the membership degree of environmental data corresponding to pₓ, and x meets 1≤x≤n. When the fusion probability is determined by using the fire alarming device described in the embodiments of the present disclosure, wₓ may be the membership degree calculated and determined in advance by the above sub-steps 2031 to 2032 and stored in in the fire alarming device.

In step 205: the fire alarming device sends alarm information to a first terminal when the fusion probability is larger than a specified probability value.

The first terminal may be a user terminal, and the user terminal is controlled by a user. For example, the user terminal is a mobile terminal held by the user (the mobile terminal may be a mobile phone or various smart wearable devices). The alarm information may be voice information, optical information (such as flash) or text information. The alarm information may be pre-edited and pre-stored in the fire alarming device. In addition, the alarm information may further include address information where the fire alarming device is located.

The specified probability value may be a preset probability value in the fire alarming device, and the probability value may be correspondingly adjusted according to different places where the fire alarming device is located, which is not limited by the embodiments of the present disclosure. The fire alarming device may be connected to the first terminal in a manner of wireless or wired communication. When the fusion probability is larger than the specified probability value, the fire alarming device may send the alarm information to the first terminal in the manner of wireless or wired communication.

In summary, the fire alarming method provided by the embodiments of the present disclosure acquires a plurality of environmental data, and determines the fire probabilities corresponding to each environmental data according to the plurality of environmental data. Then, a fusion probability corresponding to the plurality of environmental data is acquired in combination of the membership degree corresponding to each of the plurality of environmental data. When the fusion probability is larger than a specified probability value, alarm information is sent. The fusion probability is the probability determined by comprehensively considering multiple types of environmental data, thereby solving the problem that the accuracy of the alarm information in the related art is relatively low, and improving the accuracy of an alarming result sent by the fire alarming device.

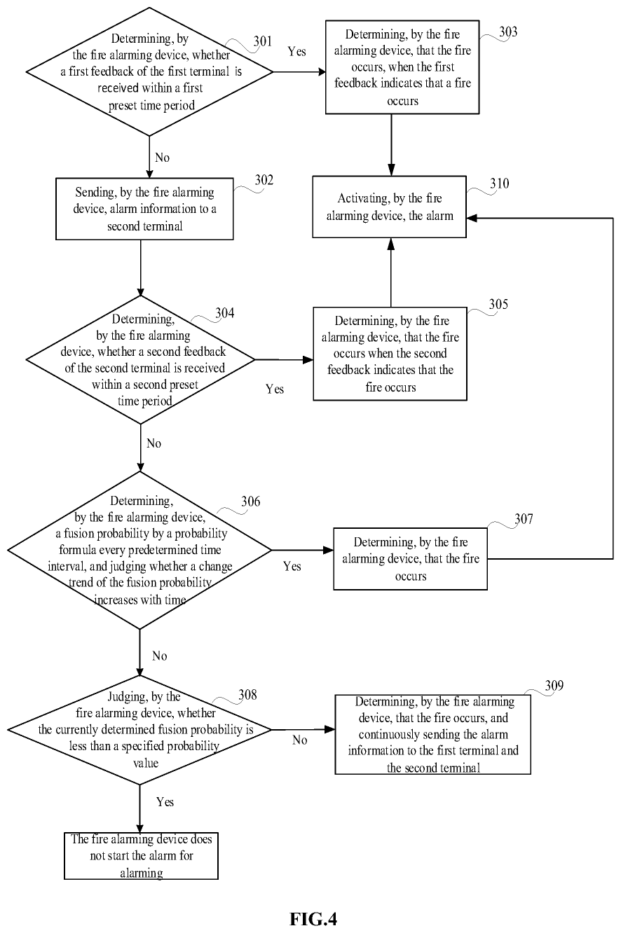

In a possible embodiment, the fire alarming device can send the alarm information in multiple manners. Exemplarily, as shown in FIG. 4, step 205 in the above embodiments may include the following steps.

Step 301: the fire alarming device determines whether a first feedback of the first terminal is received within a first preset time period. When the first feedback of the first terminal is not received within the first preset time period, step 302 is performed. When the first feedback of the first terminal is received within the first preset time period, step 303 is performed.

The first feedback is configured to indicate whether a fire occurs. The first preset time period is a preset time period. For example, the preset time period may be ten minutes, which is not limited by the embodiments of the present disclosure.

After the first terminal receives the alarm information sent by the fire alarming device, the user may judge according to the content of the alarm information in the first preset time period, and send the judging result back to the fire alarming device in the form of the first feedback.

Optionally, the step 301 may be an optional step. That is, when the fire alarming device receives the first feedback of the first terminal within the first preset time period, the step 303 may be performed without performing a judging operation. Correspondingly, when the fire alarming device does not receive the first feedback of the first terminal within the first preset time period, the step 302 may be performed without performing the judging operation.

In step 302, the fire alarming device sends alarm information to a second terminal, and step 304 is performed.

In order to ensure that the alarming of the fire alarming device can be timely and effectively fed back and processed, the fire alarming device may also send the alarm information to the second terminal when not receiving the first feedback of the first terminal within the first preset time period. The second terminal may be a property terminal, and the property terminal is controlled by property staff. For example, the property terminal may be a terminal owned by the property staff, and the fire alarming device may be connected to the second terminal in the manner of wireless or wired communication. The alarm information may be the same alarm information as that sent to the first terminal, or may be the alarm information different from that sent to the first terminal, which is not limited by the embodiments of the present disclosure.

In step 303, when the first feedback indicates that a fire occurs, the fire alarming device determines that the fire occurs, and step 310 is performed.

When the first feedback sent by the first terminal indicates that the fire occurs, the fire alarming device can determine that the fire occurs. When the first feedback of the first terminal is received within the first preset time period, but the first feedback indicates that no fire occurs, the fire alarming device can determine that no fire occurs. The fire alarming device does not start the alarm for alarming, and the above step 201 is performed again.

In step 304, the fire alarming device determines whether a second feedback of the second terminal is received within a second preset time period. When the second feedback of the second terminal is received within the second preset time period, step 305 is performed. When the second feedback of the second terminal is not received within the second preset time period, step 306 is performed.

Similar to the first feedback, the second feedback is also configured to indicate whether the fire occurs. The second preset time period is also a preset time period, for example, the preset time period is ten minutes, which is not limited by the embodiments of the present disclosure. After the second terminal receives the alarm information sent by the fire alarming device, the property staff can judge according to the content of the alarm information within the second preset time period, and send the judging result back to the fire alarming device in the form of the second feedback.

In step 305, when the second feedback indicates that the fire occurs, the fire alarming device determines that the fire occurs, and step 310 is performed.

When the second feedback sent by the second terminal indicates that the fire occurs, the fire alarming device can determine that the fire occurs, and start the alarm for alarming. When the second feedback of the second terminal is received within the second preset time period, but the second feedback indicates that the fire occurs, the fire alarming device can determine that no fire occurs, and the fire alarming device does not start the alarm for alarming, and the above step 201 is performed again.

It can be seen from the above steps 301 to 305 that the fire alarming method described in the embodiments of the present disclosure can send the alarm information to the first terminal, and can continue to send the alarm information to the second terminal when the feedback of the first terminal is not received, thereby ensuring that the alarm information can be processed effectively and timely, and effectively reducing the influence caused by the fire.

In step 306, the fire alarming device determines a fusion probability by a probability formula every predetermined time interval, and judges whether a change trend of the fusion probability increases with time. When the change trend of the fusion probability increases with time, step 307 is performed. When the change trend of the fusion probability does not increase with time, step 308 is performed.

When not receiving the second feedback of the second terminal within the second preset time period, the fire alarming device may learn a development trend of the fire probability in time by determining a fusion probability every predetermined time interval and judging the change trend of the fusion probability, and take a corresponding measure for the development trend.

In step 307, the fire alarming device determines that the fire occurs, and step 310 is performed.

When the change trend of the fusion probability increases with time, the possibility that the fire occurs is relatively large, and the fire alarming device can determine that the fire occurs.

In step 308, the fire alarming device judges whether the currently determined fusion probability is less than a specified probability value. When the currently determined fusion probability is not less than the specified probability value, step 309 is performed. When the currently determined fusion probability is less than the specified probability value, it can be determined that no fire occurs, and the fire alarming device does not start the alarm for alarming.

In step 309, the fire alarming device determines that the fire occurs, and continuously sends the alarm information to the first terminal and the second terminal.

When the currently determined fusion probability is not lower than the specified probability value, it can be indicated that the environmental data currently acquired by the sensing module has no trend of decrease, and at this point there is still a risk of fire. Then the fire alarming device may continuously send the alarm information to the first terminal and/or the second terminal until the first terminal and/or the second terminal take(s) corresponding operations for the alarm information, for example, the alarm is activated.

In step 310, the fire alarming device activates the alarm.

The fire alarming device also includes an alarm. After determining that the fire occurs, the alarm can be activated for alarming.

Optionally, the alarm may be connected to the network of a firefighting center. After determining that the fire occurs, the alarm sends the alarm information is sent to the firefighting center.

Optionally, the alarm may include an audible alarm component. The audible alarm component can alert by making a sound after determining that the fire occurs. In addition, the alarm may also include an audible-optical alarm component, and the audible-optical alarm component can alert by both of sound and light (the light can be red) to further improve the alarming effect.

In summary, the fire alarming method provided by the embodiments of the present disclosure acquires a plurality of environmental data, and determines the fire probabilities corresponding to each environmental data according to the plurality of environmental data. Then, a fusion probability corresponding to the plurality of environmental data is acquired in combination of the membership degree corresponding to each of the plurality of environmental data. When the fusion probability is larger than a specified probability value, alarm information is sent. The fusion probability is the probability determined by comprehensively considering multiple types of environmental data, thereby solving the problem that the accuracy of the alarm information in the related art is relatively low, and improving the accuracy of an alarming result sent by the fire alarming device.

In a possible embodiment, the sensing module may include a visual sensor, and then the n types of environmental data acquired by the sensing module may include the images of a surrounding environment acquired by the visual sensor. Depending on the number of the acquired images, the following two cases are taken as an example for illustration.

In the first case, the n types of environmental data acquired by the sensing module may include the image acquired by the visual sensor at the current moment. Then, in the above step 102 and step 202, the step of determining the fire probability corresponding to each type of environmental data according to the n types of environmental data may include: inputting the image acquired by the visual sensor at the current moment into a fire model, and acquiring the fire probability corresponding to the image acquired by the visual sensor at the current moment. The fire model is configured to determine a fire occurrence probability according to the image.

The fire model is a fire model acquired by training a convolutional neural network (CNN) with a sample set as training data. The fire model is configured to determine the fire occurrence probability according to the image. The fire model sample set includes a plurality of image samples. The plurality of image samples includes h1 image samples in which the fire occurs and h2 image samples in which no fire occurs, and h1 and h2 are both integers larger than or equal to 1. The image samples may be expanded as the increasing of times of using the fire alarming method described in the embodiments of the present disclosure. According to the alarming result, the image samples are accurately classified, and the image samples in which the fire occurs and the image samples in which no fire occurs are determined, so that the sample set can be continuously updated. Therefore, the fire model can be repeatedly trained many times based on the updated sample set, so as to increase the accuracy of determining the fire occurrence probability by the fire model according to the images.

The CNN may be an object detection network such as a single shot multibox detector (SSD) network model or a faster region with CNN features (Faster-RCNN), which is not limited by the embodiments of the present disclosure.

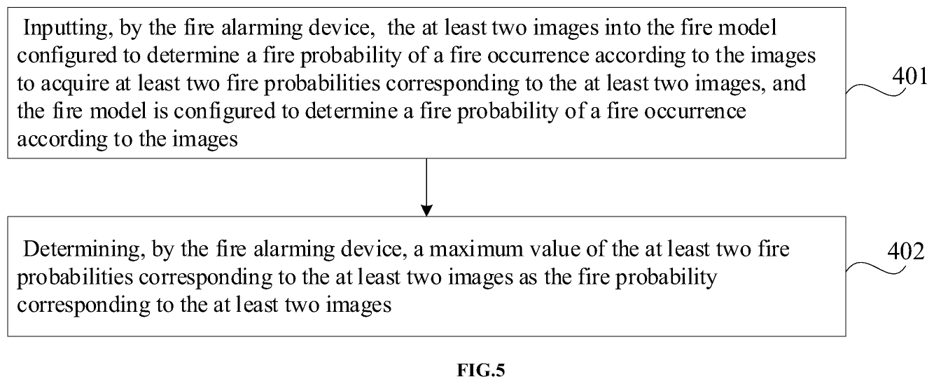

In the second case, the n types of environmental data acquired by the sensing module include at least two images acquired by the visual sensor at different moments in the preset time period. The preset time period is the time period including the current moment and before the current moment, that is, the preset time period is the time period in which the current moment is the final moment. Exemplarily, the current moment is 02:00, so the preset time period may be the time period of 01:30-02:00, which includes the moment of 02:00 and takes the moment of 02:00 as the final moment. The n types of environmental data include the image acquired by the visual sensor at the current moment. As shown in FIG. 5, the method for determining the fire probability corresponding to each type of environmental data according to the n types of environmental data may include the following two steps.

In step 401, the fire alarming device inputs the at least two images into the fire model to acquire at least two fire probabilities corresponding to the at least two images, and the fire model is configured to determine a fire probability of a fire occurrence according to the images.

In step 402, the fire alarming device determines a maximum value of the at least two fire probabilities corresponding to the at least two images as the fire probability corresponding to the at least two images.

Optionally, the fire alarming device may further determine an average value of the at least two fire probabilities corresponding to the at least two images as the fire probability corresponding to the at least two images.

The related introduction of the fire model may refer to the first case mentioned above, which is not repeated herein. In the second case, the fire probability can be more accurately determined in combination with the images acquired by the visual sensor at different moments, thereby improving the accuracy of the alarming result sent by the fire alarming device, and also increasing the reliability of the fire alarming device.

In the embodiments of the present disclosure, the fire model may be separately established based on the environment in which each fire alarming device is located (i.e., the fire alarming device is in a one-to-one correspondence with the fire model). The image samples for establishing the fire model may include the image samples in which the fire occurs and the image samples in which no fire occurs in the environment where the fire alarming device is located. The fire model may also be established based on the environments in which the plurality of fire alarming devices are located together (i.e., one fire model corresponds to the plurality of fire alarming devices), and the image samples for establishing the fire model may include the image samples in which the fire occurs and the image samples in which no fire occurs in the environment where the plurality of fire alarming devices are located. For the case of separately establishing the fire model, all the image samples in the sample set required to establish the fire model are image samples in the same environment. Therefore, the image features of the environment where the fire alarming device is located can be extracted more accurately, and the image features related to the fire can be extracted more accurately, thereby improving the accuracy of determining the fire occurrence probability by the fire model according to the images. For the case of establishing the fire model together, the fire model can be established based on a large number of image samples, and the fire-related image features can be classified in detail, thereby improving the accuracy of determining the fire occurrence probability by the fire model according to the images.

In the embodiments of the present disclosure, since the sensing module may include a visual sensor, the n types of environmental data acquired by the sensing module may include the image of a surrounding environment acquired by the visual sensor. In the above step 105, the alarm information sent by the fire alarming device to the first terminal may include the image collected by the visual sensor at the current moment. The user of the first terminal may judge the fire situation according to the image, and send the judging result back to the fire alarming device in the form of the first feedback. Similarly, for the above step 302, the alarm information sent by the fire alarming device to the second terminal may also include the image collected by the visual sensor at the current moment. The property staff of the second terminal may also judge the fire situation according to the image, and send the judging result back to the fire alarming device in the form of the second feedback. The alarm information includes real-time images of the fire, which can make the alarm information more accurate and reliable. The users and the property staff can observe the fire situation in real time, thereby further improving the alarming accuracy of the fire alarming device, and avoiding the occurrence of false alarm, alarm delay or the like.

Optionally, in the above steps, the image samples in which no fire occurs may also be acquired according to the first feedback and the second feedback respectively sent by the first terminal and the second terminal. For example, when the first terminal receives the alarm information including the images of the surrounding environment acquired by the visual sensor, it is indicated that no fire occurs. The fire alarming device can then add the image as the image sample in which no fire occurs to the sample set. Correspondingly, after the second terminal receives the alarm information including the image of the surrounding environment acquired by the visual sensor, it is indicated that no fire occurs, then the fire alarming device may also add the image as the image sample in which no fire occurs to the sample set. Since the sample set can be continuously expanded by the fire alarming device, the accuracy of determining the fire occurrence probability by the fire model according to the images is further improved.

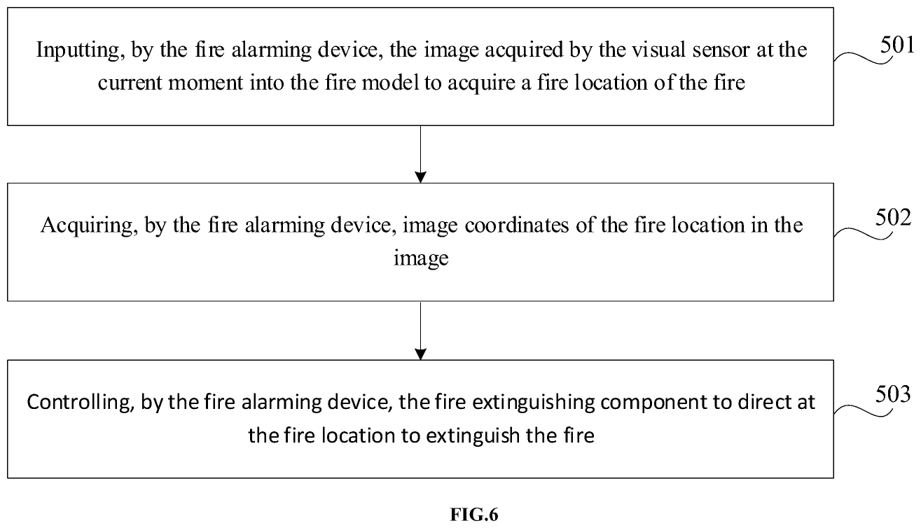

Optionally, the fire alarming device may further include a fire extinguishing component. The fire model is the fire model established based on the convolutional neural network. Therefore, the fire model can be configured to classify and detect the fire. With the classification of the fire, the fire model can acquire the fire probability (refer to the two above cases), and with the detection of the fire, the fire model can also determine a fire location according to the images. After determining that the fire occurs via the above steps, as shown in FIG. 6, the fire alarming method further includes the following steps.

In step 501, the fire alarming device inputs the image acquired by the visual sensor at the current moment into the fire model to acquire a fire location of the fire.

In step 502, the fire alarming device acquires image coordinates of the fire location in the image.

Herein, the fire alarming device can convert the image coordinates into world coordinates in a world coordinate system according to a coordinate conversion formula, and the coordinate conversion formula may be:

$$[ \begin{matrix}u \\ v \\ 1\end{matrix} ] = k [ \begin{matrix}fu & 0 & u 0 \\ 0 & fv & v 0 \\ 0 & 0 & 1\end{matrix} ] [ \begin{matrix}R & T \\ 0 & 1\end{matrix} ] [ \begin{matrix}X \\ Y \\ Z\end{matrix} ] .$$

Herein, u and v are image coordinates, and fu is a focal length of the visual sensor in an x-axis direction. fv is a focal length of the visual sensor in a y-axis direction. k is a scale factor. u0 is an optical center coordinate of the visual sensor in the x-axis direction. v0 is an optical center coordinate of the visual sensor in the y-axis direction. R is a rotation vector of the visual sensor. T is a translation vector of the visual sensor. X, Y, and Z are the world coordinates.

Herein, fu, fv, u0 and v0 are internal parameters of a camera in the visual sensor, and can be acquired through a calibration algorithm. For example, the calibration algorithm can be the Zhang Zhengyou calibration algorithm. The process of determining the three internal parameters may be: firstly, placing an image with a checkerboard in front of the camera in the visual sensor, and collecting at least three images having different angles and positions. The at least three images are called as calibration images of the camera in the visual sensor. Then the calibration images are processed by using the Zhang Zhengyou calibration algorithm to acquire the internal parameters, i.e., fu, fv, u0 and v0 of the camera in the visual sensor.

R and T are external parameters of the camera in the visual sensor. The central position of a checkerboard calibration plate and the origin point of the world coordinate system are coincided and placed on the ground. Six angle points are selected on the checkerboard calibration plate, and the world coordinates of the six angle points are respectively recorded. A frame of the image is acquired by using the camera in the visual sensor, and the pixel coordinates of the six angle points are extracted from the image. By using such six coordinate point pairs (each angle point includes a world coordinate and a pixel coordinate), 12 external parameters can be calculated. In order for an accurate calculation, the checkerboard calibration plate may be placed on the ground at different positions, and the above process is repeated. The external parameters acquired at different times are processed (for example, averaged) to acquire the determined external parameters of the camera.

In step 503, the fire alarming device controls the fire extinguishing component to direct at the fire location to extinguish the fire.

Optionally, the fire extinguishing component may include the parts such as a fire extinguishing solenoid valve, a fire extinguishing agent pipe, a fire extinguishing agent tank, and a sprayer. When the fire extinguishing solenoid valve receives an instruction of extinguishing the fire from the fire alarming device, the fire extinguishing solenoid valve is turned on. The parts such as the fire extinguishing agent pipe, the fire extinguishing agent tank and the sprayer in the fire extinguishing component perform fire extinguishment at the fire location. The angle of the sprayer can be automatically adjusted during the fire extinguishment process. For example, the fire extinguishing component may include a rotating component. The rotating component is connected to the sprayer and can adjust an orientation angle of the sprayer under the control of the fire alarming device to direct at the sprayer in the fire location.

By providing the fire extinguishing component in the fire alarming device, the fire alarming device can control the fire to a certain extent before firefighters reach a fire scene, thereby reducing the huge loss of life and property. In one application scenario which may be a domestic kitchen or other places where flammable materials exist, the fire extinguishing component may be located in a position in the kitchen which does not affect the normal use of the kitchen, such as the ceiling. Herein, a fire extinguishing agent in the fire extinguishing component may be water, and the sprayer of the fire extinguishing component may be connected to a water pipe in the kitchen. When the fire occurs in the kitchen, the fire extinguishing component can direct at the fire location for fire extinguishment under the control of the fire alarming device.

In summary, the fire alarming device provided by the embodiments of the present disclosure acquires the fire probabilities corresponding to the plurality of environmental data, and determines the fusion probability of the fire occurrence based on the fire probabilities corresponding to the plurality of environmental data. When the fusion probability is larger than a specified value, alarm information is sent. The fusion probability is a probability determined by comprehensively considering multiple types of environmental data, and the accuracy is relatively high, thereby solving the problem that the accuracy of the alarm information in the related art is relatively low. The effect of improving the accuracy of an alarming result sent by the fire alarming device is achieved.

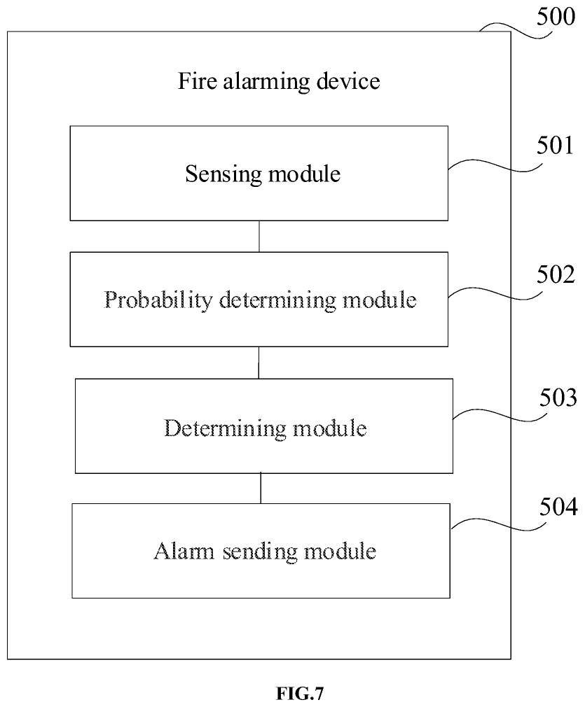

FIG. 7 is a schematic diagram of a structure of a fire alarming device 500 according to an embodiment of the present disclosure. The fire alarming device 500 includes following module:

a sensing module 501, configured to acquire the n types of environmental data at a current moment through the sensing module.

a probability determining module 502, configured to determine a fire probability corresponding to each type of environmental data according to the n types of environmental data.

a determining module 503, configured to determine a fusion probability of the n types of environmental data according to the n types of environmental data and the fire probability corresponding to each type of environmental data; and

an alarm sending module 504, configured to send alarm information when the fusion probability is larger than a specified probability value.

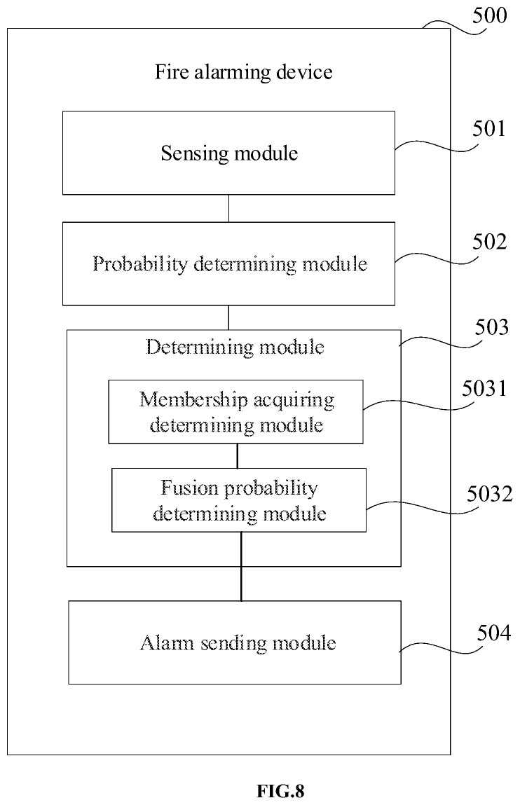

Optionally, as shown in FIG. 8, it is a schematic diagram of a structure of another fire alarm device provided by the embodiments of the present application. The determining module 503 includes:

a membership acquiring module 5031, configured to acquire a membership degree of each of the n types of environmental data; and

a fusion probability determining module 5032, configured to determine the fusion probability based on the fire probability corresponding to each type of environmental data and the membership degree of each type of environmental data.

Optionally, a sum of the membership degrees of the n types of environmental data is 1.

The fusion probability determining module 504 is configured to determine the fusion probability according to a probability formula of P=p₁w₁+p₂w₂L+pₙwₙ, wherein P is the fusion probability, pₓ is the fire probability corresponding to one of the n types of environmental data, wₓ is the membership degree corresponding to the environmental data corresponding to pₓ, and x satisfies 1≤x≤n.

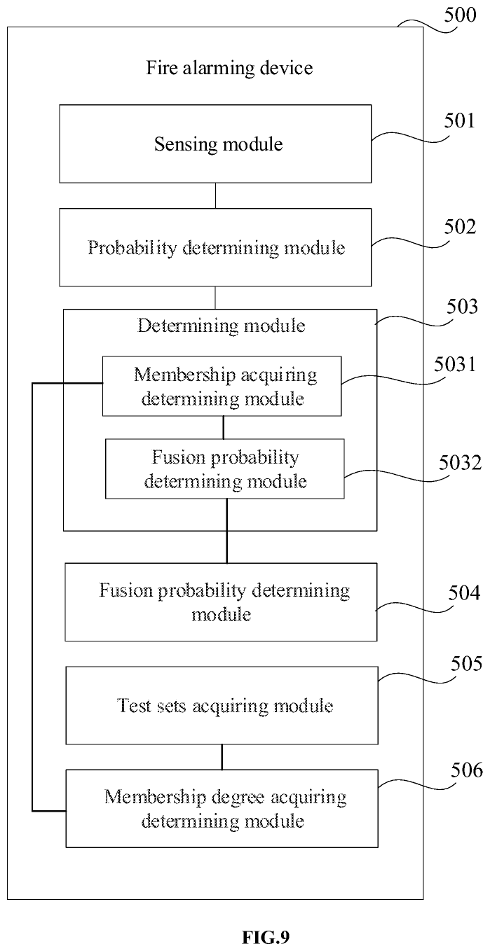

Optionally, as shown in FIG. 9, it is a schematic diagram of a structure of another fire alarm device provided by an embodiment of the present application. The fire alarm device 500 also includes the following modules.

A test sets acquiring module 505, configured to acquire m test sets, wherein each test set comprises the fire probabilities corresponding to the n types of environmental data at any moment prior to the current moment and an actual fire probability of the any moment prior to the current moment which are acquired by the sensing module.

A membership degree determining module 506, configured to determine the membership degree of each type of environmental data which minimizes a value of a loss function according to the m test sets, the loss function being L=Σᵢ₌₁^{m}(Yᵢ−Pᵢ)².

Herein, P=pᵢ₁w₁+pᵢ₂w₂L+pᵢₙwₙ, L is the value of the loss function, Yᵢ is the actual fire probability in an i-th test set, Yᵢ is one of 0 and 1, pᵢₓ is the fire probability corresponding to one type of environmental data in the i-th test set, and x satisfies 1≤x≤n.

Optionally, the alarm sending module 505 is configured to send the alarm information to a first terminal when the fusion probability is larger than the specified probability value; and send the alarm information to a second terminal when a first feedback of the first terminal is not received within a first preset time period.

In summary, the fire alarming device provided by the embodiments of the present disclosure acquires the fire probabilities corresponding to the plurality of environmental data, and determines the fusion probability of the fire occurrence based on the fire probabilities corresponding to the plurality of environmental data. When the fusion probability is larger than a specified value, alarm information is sent. The fusion probability is a probability determined by comprehensively considering multiple types of environmental data, and the accuracy is relatively high, thereby solving the problem that the accuracy of the alarm information in the related art is relatively low. The effect of improving the accuracy of an alarming result sent by the fire alarming device is achieved.

There is provided a fire alarming device in the embodiments of the present disclosure, including:

a sensing module and one or more processors; and

a memory;

wherein the memory stores therein one or more programs configured to be executed by the one or more processors, and the one or more programs include instructions for performing following operations:

acquiring the n types of environmental data at a current moment through the sensing module;

determining a fire probability corresponding to each type of environmental data according to the n types of environmental data;

determining a fusion probability of the n types of environmental data according to the n types of environmental data and the fire probability corresponding to each type of environmental data; and

sending alarm information when the fusion probability is larger than a specified probability value.

Optionally, the one or more programs include instructions for performing following operations:

acquiring a membership degree of each of the n types of environmental data; and

determining the fusion probability based on the fire probability corresponding to each type of environmental data and the membership degree of each type of environmental data.

Optionally, a sum of the membership degrees of the n types of environmental data is 1; and the one or more programs include instructions for performing following operation:

determining the fusion probability according to a probability formula of P=p₁w₁+p₂w₂L+pₙwₙ, wherein P is the fusion probability, pₓ is the fire probability corresponding to one of the n types of environmental data, wₓ is the membership degree of the environmental data corresponding to pₓ, and x satisfies 1≤x≤n.

Optionally, the one or more programs include instructions for performing following operations:

acquiring m test sets, wherein each test set comprises the fire probabilities corresponding to the n types of environmental data acquired by the sensing module at any moment prior to the current moment and an actual fire probability of the any moment prior to the current moment;

determining the membership degree of each type of environmental data which minimizes a value of a loss function according to the m test sets, the loss function being:

L=Σᵢ₌₁^{m}(Yᵢ−Pᵢ)², wherein P=pᵢ₁w₁+pᵢ₂w₂L+pᵢₙwₙ, L is the value of the loss function, Yᵢ is the actual fire probability in an i-th test set, Yᵢ is one of 0 and 1, pᵢₓ is the fire probability corresponding to one type of environmental data in the i-th test set, and x satisfies 1≤x≤n.

Optionally, the one or more programs include instructions for performing following operations:

sending the alarm information to a first terminal when the fusion probability is larger than the specified probability value; and

sending the alarm information to a second terminal when a first feedback of the first terminal is not received within a first preset time period.

There is provided a fire alarming device in the embodiments of the present disclosure, including a sensing module for acquiring n types of environmental data, a memory, a processor and computer programs stored in the memory and operated in the processor, wherein n is larger than or equal to two. The processor can perform the computer programs for implementing the fire alarming method described in the above embodiments.

Optionally, the fire alarming device may further include a fire extinguishing component, an alarm, etc.

Persons of ordinary skill in the art can clearly understand that, for the convenience and conciseness of description, the device described above may be made reference to the corresponding description in the above fire alarming methods, which are not repeated herein.

There is provided a computer readable storage medium in the embodiments of the present disclosure, including instructions that, when operated in the computer, cause the computer to implement the fire alarming method described in the above embodiments.

There is provided a computer program product in the embodiments of the present disclosure, including instructions that, when operated in the computer, cause the computer to implement the fire alarming method described in the above embodiments.

There is provided a chip in the embodiments of the present disclosure, including programmable logic device and/or program instructions. The chip operates to implement the fire alarming method described in the above embodiments.

In the present disclosure, the term “and/or” herein merely describes the correspondence of the corresponding objects, indicating three kinds of relationship. For example, A and/or B may indicate that A exists alone, A and B exist concurrently, and B exists alone. The character “/” generally indicates that an “OR” relationship exists among the context objects.

In the present disclosure, the terms “first”, “second”, “third”, and “fourth” are merely used for description, and shall not be construed as indicating or implying relative importance. Unless otherwise indicated, the term “plurality” refers to two or more.

The foregoing descriptions are merely optional embodiments of the present disclosure, and are not intended to limit the present disclosure. Within the spirit and principles of the disclosure, any modifications, equivalent substitutions, improvements, etc., are within the protection scope of the present disclosure.

What is claimed is:

1. A fire alarming method, applied on a fire alarming device, wherein the fire alarming device comprises a sensing module for acquiring n types of environmental data, n is larger than or equal to two, and the method comprises:
acquiring the n types of environmental data at a current moment through the sensing module;
determining a fire probability corresponding to each type of environmental data according to the n types of environmental data;
determining a fusion probability of the n types of environmental data according to the n types of environmental data and the fire probability corresponding to each type of environmental data; and
sending alarm information when the fusion probability is larger than a specified probability value.

2. The method according to claim 1, wherein determining a fusion probability of the n types of environmental data according to the n types of environmental data and the fire probability corresponding to each type of environmental data comprises:
acquiring a membership degree of each of the n types of environmental data; and
determining the fusion probability based on the fire probability corresponding to each type of environmental data and the membership degree of each type of environmental data.

3. The method according to claim 2, wherein a sum of the membership degrees of the n types of environmental data is 1:
determining the fusion probability based on the fire probability corresponding to each type of environmental data and the membership degree of each type of environmental data comprises:
determining the fusion probability according to a probability formula of P=p₁w₁+p₂w₂L+pₙwₙ, wherein P is the fusion probability, pₓ is the fire probability corresponding to one of the n types of environmental data, wₓ is the membership degree of the environmental data corresponding to pₓ, and x satisfies 1≤x≤n.

4. The method according to claim 2, wherein before acquiring a membership degree of each of the n types of environmental data, the method further comprises:
acquiring m test sets, wherein each test set comprises the fire probabilities corresponding to the n types of environmental data acquired by the sensing module at any moment prior to the current moment and an actual fire probability at the any moment prior to the current moment;
determining the membership degree of each type of environmental data which minimizes a value of a loss function according to the m test sets, the loss function being:
L=Σᵢ₌₁^{m}(Yᵢ−Pᵢ)²,
wherein P=pᵢ₁w₁+pᵢ₂w₂L+pᵢₙwₙ, L is the value of the loss function, Yᵢ is the actual fire probability in an i-th test set, Yᵢ is one of 0 and 1, pᵢₓ is the fire probability corresponding to one type of environmental data in the i-th test set, and x satisfies 1≤x≤n.

5. The method according to claim 4, wherein determining the membership degree of each type of environmental data which minimizes a value of a loss function comprises:
determining the membership degree of each type of environmental data which minimizes the value of the loss function by using a gradient descent algorithm.

6. The method according to claim 1, wherein sending alarm information when the fusion probability is larger than a specified probability value comprises:
sending the alarm information to a first terminal when the fusion probability is larger than the specified probability value; and
sending the alarm information to a second terminal when a first feedback of the first terminal is not received within a first preset time period.

7. The method according to claim 6, further comprising:
determining that a fire occurs when the first feedback of the first terminal is received within the first preset time period, and the first feedback indicates that the fire occurs; and
determining that a fire occurs when a second feedback of the second terminal is received within a second preset time period, and the second feedback indicates that the fire occurs.

8. The method according to claim 7, further comprising:
determining the fusion probability through the probability formula every predetermined time interval when the second feedback of the second terminal is not received within the second preset time period;
determining that the fire occurs when a change trend of the fusion probability increases with time;
judging whether the currently determined fusion probability is less than the specified probability value when the change trend of the fusion probability does not increase with time; and
determining that the fire occurs, and continuously sending the alarm information to the first terminal and the second terminal when the currently determined fusion probability is not less than the specified probability value.

9. The method according to claim 1, wherein the sensing module comprises a visual sensor, and the n types of environmental data comprise an image acquired by the visual sensor at the current moment,
wherein determining a fire probability corresponding to each type of environmental data according to the n types of environmental data comprises:
inputting the image acquired by the visual sensor at the current moment into a fire model to acquire the fire probability corresponding to the image acquired by the visual sensor at the current moment, the fire model being configured to determine a fire occurrence probability according to the image;
wherein the fire model is a fire model acquired by training a convolutional neural network with a sample set as training data, the fire model is configured to determine the fire occurrence probability according to the image, the sample set comprises a plurality of image samples, the plurality of image samples comprises h1 image samples in which the fire occurs and h2 image samples in which no fire occurs, and h1 and h2 are both integers larger than or equal to 1.

10. The method according to claim 9, wherein the fire alarming device further comprises a fire extinguishing component, and the fire model is further configured to determine a fire location according to the image,
after determining that the fire occurs, the method further comprises:
inputting the image acquired by the visual sensor at the current moment into the fire model to acquire the fire location of the fire; and
controlling the fire extinguishing component to direct at the fire location to extinguish the fire.

11. The method according to claim 10, wherein before controlling the fire extinguishing component to direct at the fire location to extinguish the fire, the method further comprises:
acquiring image coordinates of the fire location in the image;
converting the image coordinates into world coordinates in a world coordinate system according to a coordinate conversion formula of:
$$[ \begin{matrix}u \\ v \\ 1\end{matrix} ] = k [ \begin{matrix}fu & 0 & u 0 \\ 0 & fv & v 0 \\ 0 & 0 & 1\end{matrix} ] [ \begin{matrix}R & T \\ 0 & 1\end{matrix} ] [ \begin{matrix}X \\ Y \\ Z\end{matrix} ] ,$$
wherein u and v are the image coordinates, fu is a focal length of the visual sensor in an x-axis direction, fv is a focal length of the visual sensor in a y-axis direction, k is a scale factor, u0 is an optical center coordinate of the visual sensor in the x-axis direction, v0 is an optical center coordinate of the visual sensor in the y-axis direction, R is a rotation vector of the visual sensor, T is a translation vector of the visual sensor, and X, Y, and Z are the world coordinates.

12. The method according to claim 1, wherein the sensing module comprises a visual sensor, the n types of environmental data comprise at least two images acquired by the visual sensor at different moments of a preset time period, and the preset time period is a time period comprising the current moment and before the current moment,
the n types of environmental data comprise an image acquired by the visual sensor at the current moment,
determining a fire probability corresponding to each type of environmental data according to the n types of environmental data comprises:
inputting the at least two images into the fire model to acquire at least two fire probabilities corresponding to the at least two images, the fire model being configured to determine a fire occurrence probability according to the image; and
determining a maximum value of the at least two fire probabilities corresponding to the at least two images as a fire probability corresponding to the at least two images;
wherein the fire model is a fire model acquired by training a convolutional neural network with a sample set as training data, the fire model is configured to determine the fire occurrence probability according to the image, the sample set comprises a plurality of image samples, the plurality of image samples comprises h1 image samples in which the fire occurs and h2 image samples in which no fire occurs, and h1 and h2 are both integers larger than or equal to 1.

13. The method according to claim 5, wherein the fire alarming device further comprises an alarm, and
after determining that the fire occurs, the method further comprises:
activating the alarm.

14. A fire alarming device, comprising:
a sensor and one or more processors; and
a memory; wherein the memory stores therein one or more programs configured to be executed by the one or more processors, and the one or more programs comprise instructions for performing following operations:
acquiring the n types of environmental data at a current moment through the sensor;
determining a fire probability corresponding to each type of environmental data according to the n types of environmental data;
determining a fusion probability of the n types of environmental data according to the n types of environmental data and the fire probability corresponding to each type of environmental data; and
sending alarm information when the fusion probability is larger than a specified probability value.

15. The fire alarming device according to claim 14, wherein the one or more programs comprise instructions for performing following operations:
acquiring a membership degree of each of the n types of environmental data; and
determining the fusion probability based on the fire probability corresponding to each type of environmental data and the membership degree of each type of environmental data.

16. The fire alarming device according to claim 15, wherein a sum of the membership degrees of the n types of environmental data is 1; and the one or more programs comprise instructions for performing following operations:
determining the fusion probability according to a probability formula of P=p₁w₁+p₂w₂L+pₙwₙ, wherein P is the fusion probability, pₓ is the fire probability corresponding to one of the n types of environmental data, wₓ is the membership degree of the environmental data corresponding to pₓ, and x satisfies 1≤x≤n.

17. The fire alarming device according to claim 15, wherein the one or more programs comprise instructions for performing following operations:
acquiring m test sets, wherein each test set comprises the fire probabilities corresponding to the n types of environmental data acquired by the sensor at any moment prior to the current moment and an actual fire probability of the any moment prior to the current moment;
determining the membership degree of each type of environmental data which minimizes a value of a loss function according to the m test sets, the loss function being:
L=Σᵢ₌₁^{m}(Yᵢ−Pᵢ)²,
wherein P=pᵢ₁w₁+pᵢ₂w₂L+pᵢₙwₙ, L is the value of the loss function, Yᵢ is the actual fire probability in an i-th test set, Yᵢ is one of 0 and 1, pᵢₓ is the fire probability corresponding to one type of environmental data in the i-th test set, and x satisfies 1≤x≤n.

18. The fire alarming device according to claim 14, wherein the one or more programs comprise instructions for performing following operations:
sending the alarm information to a first terminal when the fusion probability is larger than the specified probability value; and
sending the alarm information to a second terminal when a first feedback of the first terminal is not received within a first preset time period.

19. A computer storage medium having instructions stored therein, when the instructions are run on a processor, causing the processor to perform a fire alarm method applied on a fire alarming device comprising a sensor for acquiring n types of environmental data, n is larger than or equal to two, and the method comprises:
acquiring the n types of environmental data at a current moment through the sensing module;
determining a fire probability corresponding to each type of environmental data according to the n types of environmental data;
determining a fusion probability of the n types of environmental data according to the n types of environmental data and the fire probability corresponding to each type of environmental data; and
sending alarm information when the fusion probability is larger than a specified probability value.

20. A fire alarm device, comprising a sensor for acquiring n types of environmental data a memory, a processor, and computer programs stored on the memory and capable of running on the processor, n is greater than or equal to 2, and the processor executes the computer programs for implementing the fire alarm method of claim 1.
